(19) United States
(12) Patent Application Publication
(10) Pub. No.: US 2004/0139740 A1
(43) Pub. Date: Jul. 22, 2004

(54) Exhaust gas flow circuit and decharge unit for an internal combustion engine

(76) Inventor: Reinhard Burk, Canton, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/755,458

(22) Filed: Jan. 12, 2004

Related U.S. Application Data
(60) Provisional application No. 60/439,676, filed on Jan. 13, 2003.

(51) Int. Cl. F01N 3/00; F01N 3/10; F02B 35/00

(52) U.S. Cl. 60/315; 60/299

(57) ABSTRACT

An exhaust gas flow circuit includes a pumping unit having an inlet communicating with the exhaust system, and an exhaust outlet, for pumping exhaust gas from the exhaust system to the exhaust outlet. A bypass passage is arranged in parallel flow relation with the pumping unit between the inlet and outlet. When the mass flow rate of exhaust gas is relatively high, a bypass valve opens the bypass passage providing a flow path for exhaust gas between the inlet and outlet in parallel with the pumping unit. When the mass flow rate of exhaust gas is relatively low, the bypass valve closes the bypass passage. The bypass valve can be controlled to open and close in response to engine speed or mass flow rate of exhaust gas, for example.

### CROSS-REFERENCE TO RELATED APPLICATION

This application claims the benefit of U.S. Provisional Application No. 60/439,676, filed Jan. 13, 2003.

### BACKGROUND OF THE INVENTION

The present invention relates generally to naturally aspirated internal combustion engines and, in particular, to a decharge unit to improve low-end torque at wide open throttle for a naturally aspirated engine.

A continuing goal for naturally aspirated engines is to improve low-end torque. Common methods for improving low-end torque involve installing a turbocharger or a supercharger in the engine intake system. The use of these devices, however, leads to high after-boost air temperature. An intercooler is then required to bring the air temperature down to a more manageable temperature. In addition, by installing a turbocharger or supercharger, the engine is no longer naturally aspirated. Another problem is that of back pressure, or the pressure in the exhaust system that the engine must overcome in order for the exhaust gas to flow through the exhaust system to atmosphere. Turbochargers and superchargers located in the intake system do not address the engine exhaust system back pressure. In addition, such turbochargers and superchargers are expensive, and require modifications to both the exhaust system and the intake system of the engine.

It is desirable, therefore, to provide a means for improving the low end torque for a naturally aspirated engine by reducing the back pressure of the exhaust system. It is also desirable to improve the low end torque of an internal combustion engine using inexpensive components that do not require any modification to the intake system of the engine.

### SUMMARY OF THE INVENTION

An exhaust gas flow circuit according to this invention reduces back pressure in the exhaust gas system of an internal combustion engine, increases the mass flow rate of fresh air into the combustion cylinders, provides good scavenging in the combustion cylinders, and decreases the work required to pump exhaust gas from the engine through the exhaust system.

An exhaust gas flow circuit according to this invention includes a pumping unit, such as a gas compressor, for pumping exhaust gas from the engine exhaust system through an inlet to an outlet. A power source, such as an electric motor, drives the pumping unit. A bypass passage is arranged in parallel flow relation with the pumping unit between the inlet and outlet. When the mass flow rate of exhaust gas is relatively high, a bypass valve opens the bypass passage, providing a flow path for exhaust gas between the inlet and outlet in parallel with the pumping unit. When the mass flow rate of exhaust gas is relatively low, the bypass valve closes the bypass passage. The bypass valve can be controlled to open and close in response to engine speed, which is a measure of the exhaust gas mass flow rate.

The pumping unit and motor may be enclosed in a heat resistant housing to protect them from the high temperature environment of the exhaust system.

### DESCRIPTION OF THE DRAWING

The above, as well as other advantages of the present invention, will become readily apparent to those skilled in the art from the following detailed description of a preferred embodiment when considered in the light of the accompanying drawings in which:

FIG. 1 is a schematic diagram of a decharge unit for a naturally aspirated engine in accordance with the present invention.

### DESCRIPTION OF THE PREFERRED EMBODIMENT

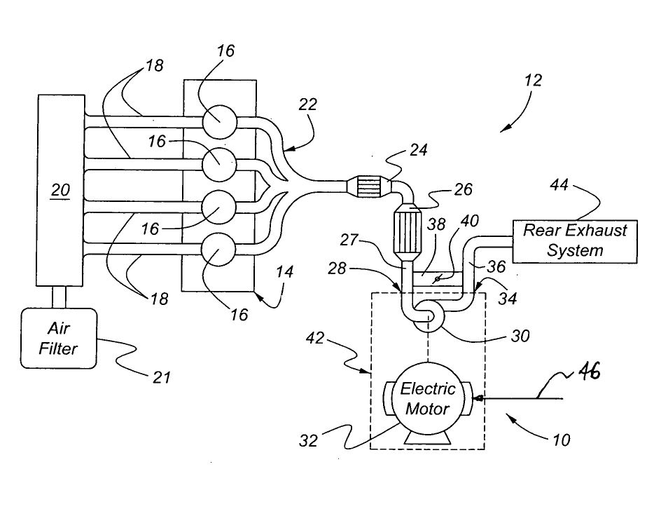

Referring now to FIG. 1, a decharge unit in accordance with the present invention is indicated generally at 10. The decharge unit 10 is disposed in an exhaust system, indicated generally at 12, of an internal combustion engine 14. The engine 14 includes a plurality of combustion cylinders 16, each of which is connected by an intake pipe 18 to an intake plenum 20. The intake plenum 20 is connected at an open end to an air filter 21. Each of the combustion cylinders 16 is connected by an exhaust manifold 22 to the exhaust system 12. The exhaust system 12 includes a first catalytic converter or catalyst device 24, connected at an inlet thereof to the exhaust manifold 22. An inlet of a second catalyst device 26 is connected to an outlet of the first catalyst device 24. An outlet of the second catalyst device 26 is connected by an exhaust pipe 27 to an inlet 28 of the decharge unit 10. The first catalyst device 24, the second catalyst device 26 and the exhaust pipe 27 form a first or forward portion of the exhaust system 12.

The inlet 28 of the decharge unit 10 is connected to an inlet of a gas compressor or gas pump 30. The compressor 30 is preferably a heat resistant compressor that is able to withstand the heat of the exhaust gas, discussed in more detail below. The compressor 30 is powered by an electric motor 32, which is connected to an electrical power source (not shown). An outlet of the compressor 30 is connected to an outlet 34 of the decharge unit 10, which is connected to a discharge pipe 36. The discharge pipe 36 extends to a conventional rear exhaust system 44 that includes an exhaust muffler and exhaust outlet. A bypass passage 38 extends between the discharge pipe 36 and the exhaust pipe 27. A bypass valve 40 is disposed in the bypass passage 38. Preferably, the decharge unit 10 is disposed in a housing 42 in order to protect the compressor 30 and the electric motor 32 from corrosion and possible foreign object damage. The discharge pipe 36 and rear exhaust system 44 form a second or rearward portion of the exhaust system 12.

In operation, air is inducted into the engine combustion cylinders 16 through the air filter 21, inlet plenum 20, and inlet piping 18. When the engine 14 is operated normally, air is mixed with fuel (not shown), and the air-fuel mixture is compressed by a piston (not shown), located in each combustion cylinder 16, and ignited, thereby producing exhaust gas. The exhaust gas is routed through the exhaust manifold 22, the first and second catalyst devices 24, 26 and to the inlet 28 of the decharge unit 10.

The compressor 30 of the decharge unit 10 pumps the exhaust gas from the exhaust system 12 to the rear exhaust system 44, thereby reducing the back pressure in the exhaust system 12 when the engine 14 is operating. When engine speed is relatively low, the bypass valve 40 is closed. When the operating speed of the engine 14 is relatively high and the engine is producing a larger exhaust gas mass flow rate than at low engine speed, the bypass valve 40 is opened. Then at least a portion of the exhaust gas bypasses the decharge unit 10 so that the decharge unit 10 does not increase the back pressure of the exhaust system 12. The electric motor 32 can be turned on and off with a control signal received on a line 46. The control signal on the line 46 can be generated in any known manner based upon, for example, sensing the engine speed or the mass flow rate of the exhaust gas in the exhaust system 12.

By decreasing the back pressure in the exhaust system 12, the decharge unit 10 according to the present invention increases the mass flow of fresh air into the combustion cylinders 16, achieves good scavenging of the combustion cylinders 16, and decreases the amount of pumping work of the engine 14.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An exhaust gas flow circuit for reducing pressure in an exhaust system of an internal combustion engine, comprising:
a pumping unit including an inlet in fluid communication with an outlet of a forward portion of the exhaust system, and an outlet in fluid communication with an inlet of a rearward portion of the exhaust system, said pumping unit selectively pumping exhaust gas from the forward portion to the rearward portion of the exhaust system; and
a power source driving said pumping unit.

2. The flow circuit of claim 1, further comprising:
a bypass passage arranged in parallel flow relation with said pumping unit between said pumping unit inlet and outlet; and
a bypass valve for opening said bypass passage and providing a flow path for exhaust gas from the forward portion to the rearward portion of the exhaust system in parallel with said pumping unit, and for closing said bypass passage to prevent exhaust gas flow therethrough.

3. The flow circuit of claim 2, wherein said bypass valve opens said bypass passage when a mass flow rate of exhaust gas in the exhaust system is relatively high and closes said bypass passage when the mass flow rate of exhaust gas is relatively low.

4. The flow circuit of claim 2, wherein said bypass valve is located in said bypass passage.

5. The flow circuit of claim 1, wherein said pumping unit is one of a gas compressor and a gas pump.

6. The flow circuit of claim 1, wherein the exhaust system further includes an exhaust manifold for carrying exhaust gas from the engine to the forward portion of the exhaust system, a catalytic converter located in the forward portion upstream from said pumping unit inlet, and a discharge pipe located in the rearward portion of the exhaust system and communicating with said pumping unit outlet for carrying exhaust gas to an outlet of the exhaust system.

7. The flow circuit of claim 1, wherein the engine includes an intake system that is naturally aspirated.

8. The flow circuit of claim 1, wherein said power source is an electric motor.

9. A decharge unit containing a flow circuit for reducing pressure in the exhaust system of an internal combustion engine, comprising:
a housing;
a pumping unit located in said housing, said pumping unit including an inlet in fluid communication with a forward portion of the exhaust system, and an outlet in fluid communication with a rearward portion of the exhaust system, said pumping unit pumping exhaust gas from the forward portion to the rearward portion; and
a power source located in said housing and driveably connected to said pumping unit.

10. The decharge unit of claim 9, further comprising:
a bypass passage arranged in parallel flow relation with said pumping unit between said inlet and outlet; and
a bypass valve for opening said bypass passage and providing a flow path for exhaust gas between said inlet and outlet in parallel with said pumping unit, and for closing said bypass passage.

11. The decharge unit of claim 10, wherein said bypass valve opens said bypass passage when a mass flow rate of exhaust gas in the exhaust system is relatively high and closes said bypass passage when the mass flow rate of exhaust gas is relatively low.

12. The decharge unit of claim 9, wherein said pumping unit is one of a gas compressor and a gas pump.

13. The decharge unit of claim 9, wherein the exhaust system further comprises:
an exhaust manifold for carrying exhaust gas from the engine to the forward portion of the exhaust system;
a catalytic converter located in the forward portion of the exhaust system upstream from said pumping unit inlet; and
a discharge pipe located in the rearward portion of the exhaust system for communicating with said pumping unit outlet to carry exhaust gas from said pumping unit outlet.

14. The decharge unit of claim 9, wherein the engine includes an intake system that is naturally aspirated.

15. The decharge unit of claim 9, wherein said power source is an electric motor.

16. An exhaust gas system for an internal combustion engine, comprising:
an exhaust manifold for carrying exhaust gas from the engine;
a catalytic converter communicating with said exhaust manifold;
a housing located downstream from said catalytic converter;
a pumping unit located in said housing, said pumping unit including an inlet in fluid communication with said catalytic converter and an outlet, said pumping unit pumping exhaust gas from said catalytic converter to said outlet; and
a power source located in the housing and driveably connected to said pumping unit.

17. The exhaust gas system of claim 16, further comprising:
a bypass passage arranged in parallel flow relation with said pumping unit between said inlet and outlet; and
a bypass valve for opening said bypass passage and providing a flow path for exhaust gas between said inlet and outlet in parallel with said pumping unit, and for closing said bypass passage.
